(19) United States
(12) Patent Application Publication
(10) Pub. No.: US 2005/0102357 A1
(43) Pub. Date: May 12, 2005

(54) Receiver supporting broadband broadcasting

(76) Inventors: Nobuhiro Shohga, Hirakata City (JP); Yoshikazu Mihara, Kawanishi City (JP); Masashi Fujita, Osaka City (JP); Ryosuke Ohtsuki, Joyo City (JP)

Correspondence Address: MCDERMOTT WILL & EMERY LLP, 600 13TH STREET, N.W., WASHINGTON, DC, 20005-3096, US

(21) Appl. No.: 10/936,785

(22) Filed: Sep. 9, 2004

(30) Foreign Application Priority Data
Sep. 12, 2003 (JP) 2003-321930

(51) Int. Cl. G06F 15/16

(52) U.S. Cl. 709/204

(57) ABSTRACT

To provide a receiver supporting broadband broadcasting, in a broadband broadcast transmission/reception system which includes a content server and a receiver supporting broadband broadcasting connected with the content server over a network. The content server has a function of transmitting data obtained by interleaving content data of a size requested from the receiver supporting broadband broadcasting, and the receiver supporting broadband broadcasting has a function of restoring the original content by deinterleaving the content data received. The receiver is provided with a content size controller for changing the size of a content requested to the content server.

### BACKGROUND OF THE INVENTION

1. Field of the Invention

The present invention relates to a receiver which supports broadband broadcasting.

2. Description of the Related Art

In the broadband broadcasting, a method of transmitting data beginning from the head, when the data is transferred, contains a risk that pieces of the data fall off sequentially if packet losses occur. To cope with this, data is packed by a certain size, parity is added thereto, and the data is interleaved, before being transmitted.

More specifically, data is virtually handled as arranged in two dimensions, as shown in FIG. 1. In FIG. 1, each of the numerals 0 to m indicates 1-byte data, respectively. The right side chart shows the one-dimensional data arranged in two dimensions by folding back the one-dimensional data per 47 bytes.

As shown in FIG. 2, four-bytes parity is added to each 47-byte data in a row, whereby each row has 51 bytes. Even when data loss occurs, the lost data can be restored from the remaining data if the loss is 4 bytes or less among 51 bytes constituting each row.

An interleave means a method of reading data, arranged in sequence shown in FIG. 1, in different order as shown in FIG. 3. The data size of the whole block (47×n in this example) is called an interleave block length.

As shown in FIG. 4, in the broadband broadcasting, a content server 1 transmits interleaved data to a client (digital television receiver) 3 over the Internet 2, and the data is deinterleaved on the client 3 side so that the original data is restored.

Conventionally, it needs a long waiting period when playing back a content. This is due to the large receiving size of data to cope with errors such as packet losses. In order to transmit interleaved data, the content server 1 forms a packet from data of the prescribed size. The plural packets formed are sequentially transmitted from the content server 1. FIG. 5a shows data transmitted in a packet where the data size to be deinterleaved is large (interleave block length is long). In the case of the data size being large as described above, even if packet losses occur, the positions of the packets lost are dispersed in different rows as shown in FIG. 5b, whereby error corrections are possible. Therefore, the loss of content data can be suppressed, which enables a stable playback.

However, if the data size to be deinterleaved becomes large, it takes time to acquire the data, resulting in a longer waiting period for starting a playback. If the data size to be deinterleaved is set to be smaller in order to cope with this problem, as shown in FIG. 6a, the data acquiring time is reduced. However, if packet losses occur as shown in FIG. 6b, the parts of the data lost concentrate on the same row. Thereby, error corrections are impossible, which results in distortions in voices and images.

### SUMMARY OF THE INVENTION

It is therefore an object of the invention to provide a receiver supporting broadband broadcasting, with which a waiting time period at the time of starting playback of a content can be reduced, and images and voices can be stable once playback of the content has been started.

The present invention relates to a receiver supporting broadband broadcasting, in a broadband broadcast transmission/reception system including a content server and a receiver supporting broadband broadcasting connected with the content server over a network. The content server has a function of transmitting data obtained by interleaving content data of a size requested from the receiver supporting broadband broadcasting, and the receiver supporting broadband broadcasting has a function of restoring the original content by deinterleaving the content data received. The receiver comprises a content size control means for changing the size of a content requested to the content server.

As the content size control means, for example, one which, at the time immediately after a content to be acquired being selected, sets the content size requested to the content server to be smaller than a predefined size, and then gradually increases the content size requested to the content server up to the predefined size, is used.

### BRIEF DESCRIPTION OF THE DRAWINGS

FIG. 1 is a schematic diagram showing one-dimensional data and a state where the one-dimensional data is arranged in two dimensions;

FIG. 2 is a schematic diagram showing a state where 4-byte parity is added to the two-dimensional array data;

FIG. 3 is a schematic diagram showing how to read data by interleaving;

FIG. 4 is a schematic diagram showing a state of transmitting/receiving content data;

FIG. 5a is a schematic diagram showing two-dimensional array data where the interleave block length is long;

FIG. 5b is a schematic diagram showing a case where error corrections are possible even if packet losses occur since the positions are dispersed in different rows, in the two-dimensional array data where the interleave block length is long as shown in FIG. 5a;

FIG. 6a is a schematic diagram showing two-dimensional array data where the interleave block length is short;

FIG. 6b is a schematic diagram showing a case where error corrections are impossible if packet losses occur since the parts of data lost concentrate on the same row, in the two-dimensional array data where the interleave block length is short as shown in FIG. 6a; and

FIG. 7 is a schematic diagram showing an example of a menu screen for selecting a content (program) of broadband broadcasting.

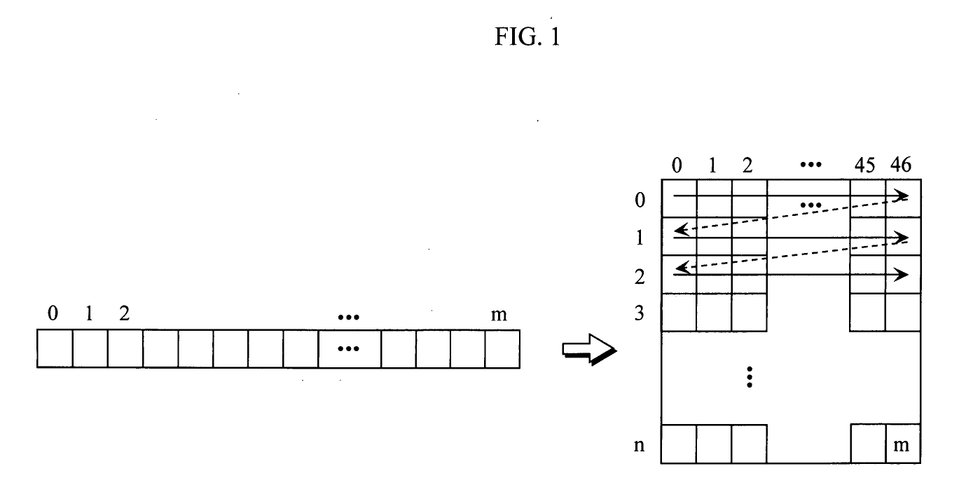

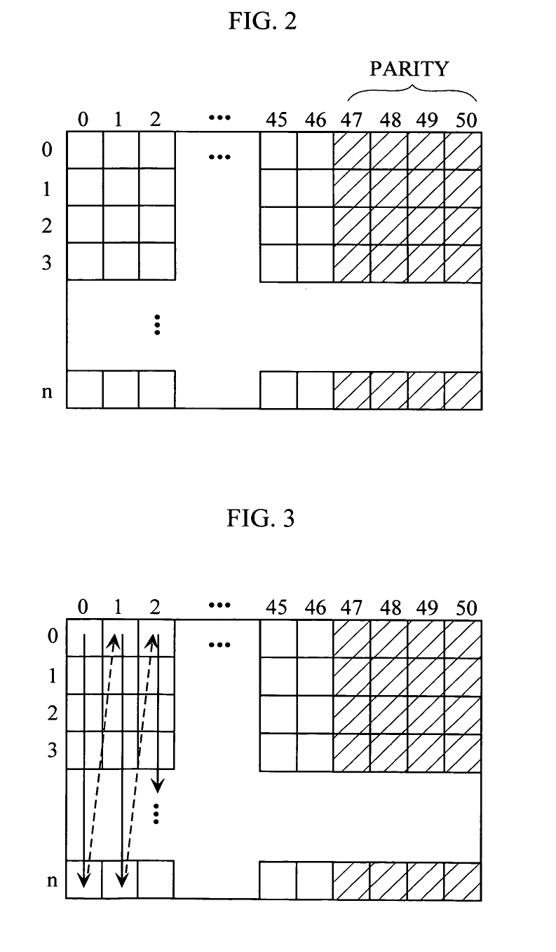

### DESCRIPTION OF THE PREFERRED EMBODIMENT

An embodiment of the present invention will be described below.

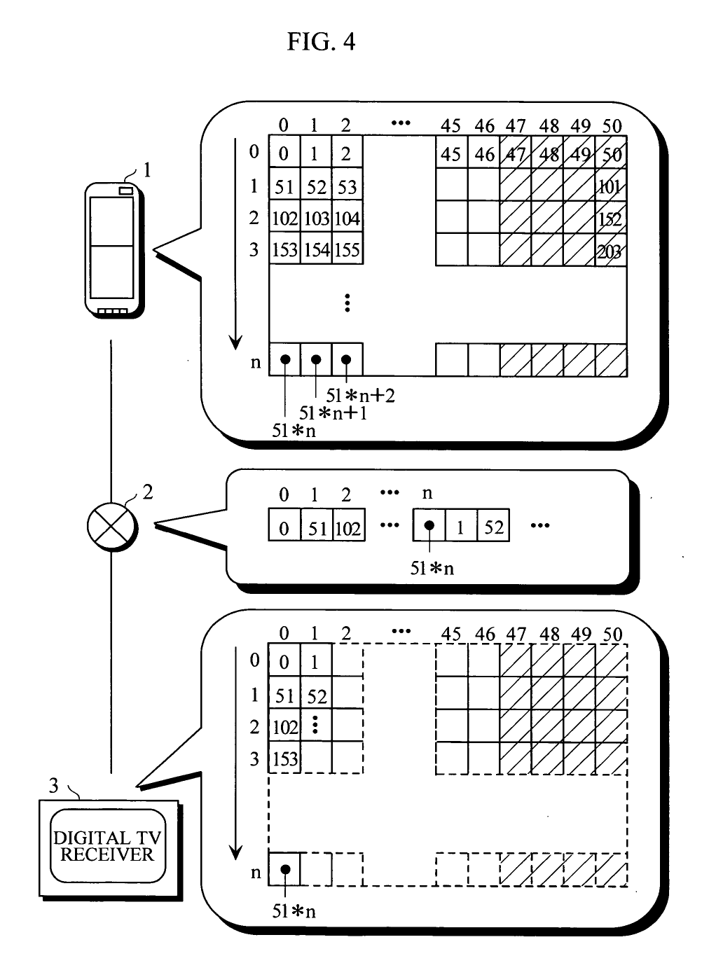

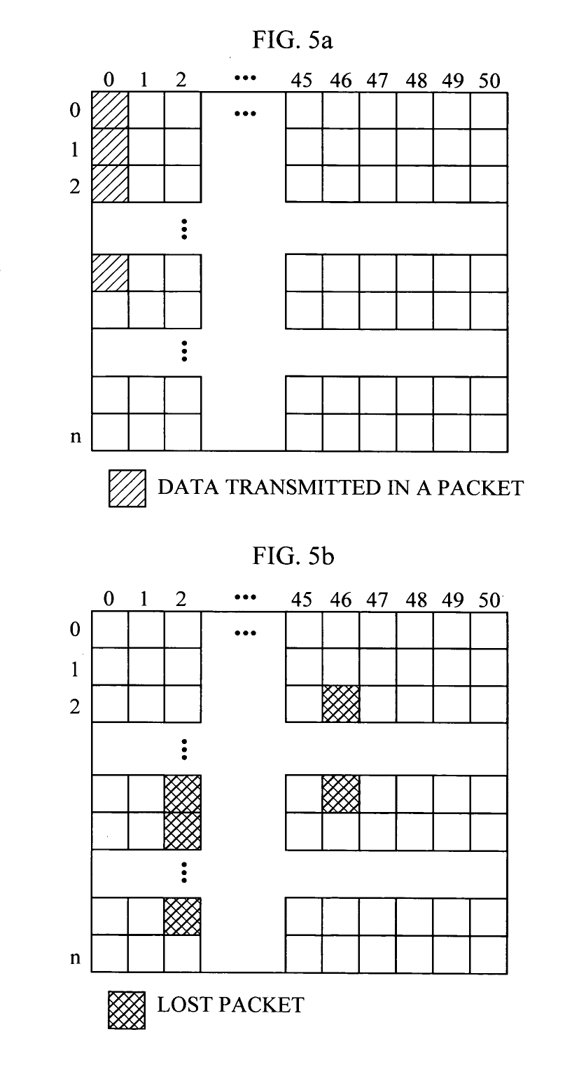

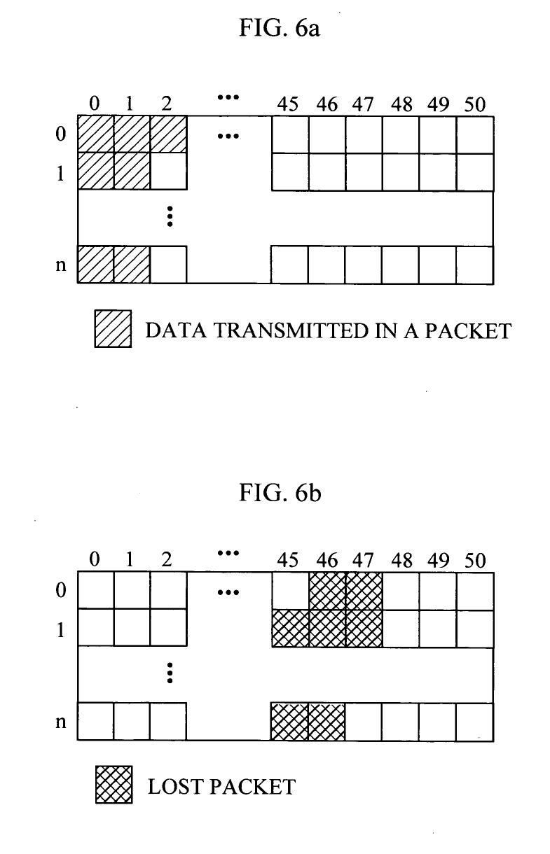

A broadband broadcasting system comprises, a content server 1, and a digital television receiver 3 supporting broadband broadcasting connected with the content server 1 over the Internet 2, as shown in FIG. 4. The digital television receiver 3 is assumed to have a function of receiving digital satellite broadcasting.

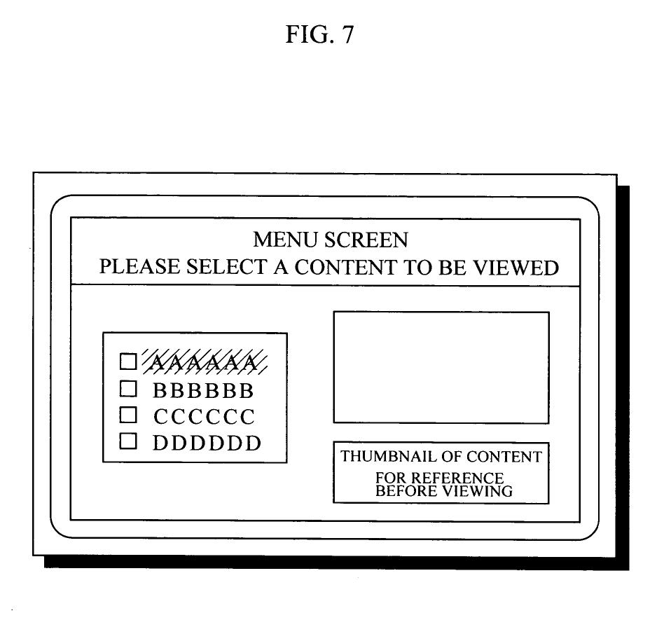

It is assumed that the receive mode of the digital television receiver 3 is set to a digital satellite broadcasting receive mode, and the digital television receiver 3 is receiving digital satellite broadcasting. That is, the user of the digital television receiver 3 is viewing a program delivered by digital satellite broadcasting. When the user manipulates a remote controller, not shown, so as to switch the receive mode of the digital television receiver 3 to the broadband broadcasting receive mode, the digital television receiver 3 operates to acquire menu screen data from the content server 1. Upon receipt of the menu screen data, the digital television receiver 3 displays the menu screen, as shown in FIG. 7.

When the user selects a desired content (program) on the menu screen, the digital television receiver 3 operates to acquire the content (program) selected by the user from the content server 1.

At this time, the digital television receiver 3 conventionally requests data of a size enough for stable playback without any distortion, for example, data for 10 seconds (hereinafter, this is called the maximum size data). However, it takes time to receive the data because of the large receiving size.

In the present embodiment, the digital television receiver 3 requests the smallest size data capable of being played back, for example, data for 1 second (hereinafter, this is called the minimum size data). Although such a small receiving size may cause distortions in playback due to errors such as packet losses, the receiving time is reduced. The reason why the receiving size is set to be small when starting playback is that users may be more satisfied with shorter waiting periods than stable playback, at the time of starting playback.

Once the playback of the content starts, the receiving size is increased since errors are likely to be caused with the current receiving size. However, if the receiving size is suddenly increased, the playback will be interrupted, since the preparation (reception, deinterleave, or the like) for displaying the subsequent content will not be completed even when the playback of the current content ends. To cope with this, the receiving size is gradually increased so as to complete the preparation for displaying the subsequent content by the end of the playback of the current content and to reduce errors due to packet losses. Once the receiving size becomes the maximum size, the receiving size is fixed to the maximum size.

Now, explanations will be given for methods of calculating the receiving size.

(1) Method of Calculating the First Receiving Size When a Desired Content is Selected by a User:

When a desired content is selected by a user, the digital television receiver 3 acquires a time corresponding to the minimum size capable to be played back by the digital television receiver 3, and obtains the initial value of the request size transmitted to the server 1.

The time corresponding to the minimum size capable of being played back by the digital television receiver 3 depends on the digital television receiver 3, which has been stored beforehand on the memory in the digital television receiver 3. The request size transmitted to the server 1 is calculated based on the bit rate of the content, and the time[sec] corresponding to the minimum size capable of being played back by the digital television receiver 3, as defined by the following equation (1):
request size[bit]=bit rate of the content[bit/sec]×time corresponding to the minimum size[sec] (1)

When the request size is calculated in this way, the digital television receiver 3 requests the content selected by the user of the calculated request size to the server 1. Then, the server 1 transmits the content of the size requested by the digital television receiver 3.

The digital television receiver 3 receives the data of the request size transmitted from the server 1, and restores the received data by deinterleaving.

(2) Method of Calculating the Subsequent Receiving Size:

A method of calculating the subsequent request size will be explained. It is assumed that a time period, required for the current request of data, reception of the data and restoration of the received data by deinterleaving, is a current processing time period. Further, a value, calculated by subtracting the current processing time period from the playback time period (output time period) as an AV content of the data currently obtained, is assumed to be a surplus time period, as shown in the following equations (2) and (3). Assuming that the time, when a data transmission is requested to the server, is the processing start time, and the time, when the received data is deinterleaved and the data restoration is completed, is the processing completion time, the current processing time period can be obtained by (processing completion time−processing start time).
surplus time[sec]=playback time[sec]−current processing time[sec] (2)
playback time [sec]=receiving size [bit]−bit rate[bit/sec] (3)

As defined by the following equation (4), a size[bit] obtainable in excess in the current data reception (hereinafter referred to as an extra size) is calculated according to the bit rate and the surplus time:
extra size[bit]=bit rate[bit/sec]×surplus time[sec] (4)

The subsequent request size is calculated according to the following equation (5):
subsequent request size[bit]=current request size[bit]+(extra size[bit]×α) (5)

Note that α is a predetermined constant, and 0<α<1. The reason why α is set to be smaller than 1 is to take into account dynamic changes in processing time due to error corrections, fluctuations in the network traffics, or the like.

Once the subsequent request size is calculated in this way, the calculated subsequent request size is judged whether it is the maximum size or more, or not. The maximum size is calculated according to the predetermined time corresponding to the maximum size, and the bit rate of the content, as defined by the following equation (6):
maximum size[bit]=bit rate of the content[bit/sec]×time corresponding to maximum size[sec] (6)

If the calculated subsequent request size is smaller than the maximum size, the data of the calculated subsequent request size is requested to the server. If the calculated subsequent request size is the maximum size or more, data of the maximum size is requested to the server. In the case that the calculated subsequent request size is the maximum size or more, the subsequent request size is fixed to the maximum size in the following processing.

1. A receiver supporting broadband broadcasting, in a broadband broadcast transmission/reception system comprising a content server and a receiver supporting broadband broadcasting connected with the content server over a network, the content server having a function of transmitting data obtained by interleaving content data of a size requested from the receiver supporting broadband broadcasting, and the receiver supporting broadband broadcasting having a function of restoring an original content by deinterleaving the content data received, wherein
the receiver comprises content size control means for changing a size of a content requested to the content server.

2. The receiver supporting broadband broadcasting as claimed in claim 1, wherein the content size control means sets, at a time immediately after a content to be acquired being selected, the content size requested to the content server to be smaller than a predefined size, and then gradually increases the content size requested to the content server up to the predefined size.
